(19) United States
(12) Patent Application Publication
(10) Pub. No.: US 2023/0129831 A1
(43) Pub. Date: Apr. 27, 2023

(54) METHOD AND SYSTEM FOR SUBSEA CABLE LOCALIZATION

(71) Applicant: Woods Hole Oceanographic Institution, Woods Hole, MA (US)

(72) Inventors: Robin H. Littlefield, Falmouth, MA (US); Karen Soenen, Falmouth, MA (US); Greg Packard, Falmouth, MA (US); Jeff Kaeli, Falmouth, MA (US)

(21) Appl. No.: 17/510,895

(22) Filed: Oct. 26, 2021

(51) Int. Cl. G01V 3/165; B63G 8/00; B63G 8/39; G01S 15/89

(52) U.S. Cl. CPC G01V 3/165; B63G 8/001; B63G 8/39; G01S 15/8902; B63G 2008/004

(57) ABSTRACT

Infrastructure monitoring relevant to offshore power cable inspection through the use of an Autonomous Underwater Vehicle (“AUV”) carrying a small magnetometer to localize and map underwater power cables. The method comprises using an AUV to cover a series of transects across a known cable corridor to localize subsea and buried power transmission cables in the marine environment for mapping and/or subsequent navigational aiding.

### CROSS REFERENCE TO RELATED APPLICATIONS

This application claims priority to the Provisional U.S. Patent Application No. 63/105,402 entitled “AUV Cable Survey,” filed Oct. 26, 2020.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### SUMMARY OF THE INVENTION

This application relates to sub-surface infrastructure monitoring relevant to offshore power cable inspection through the use of an Autonomous Underwater Vehicle (“AUV”) carrying a magnetometer to localize and map underwater power transmission cables. By surveying cables with the goal of cable localization, the disclosed method and system circumvent the difficulties associated with AUV based cable-following routines and provides a robust approach to cable localization and characterization that can inform under-sea navigation, providing improved positional accuracy for data acquisition and survey reliability for relevant stakeholders.

### DESCRIPTION OF THE DRAWINGS

The drawings constitute a part of this specification and include exemplary embodiments of the Method and System for Subsea Cable Localization, which may be embodied in various forms. It is to be understood that in some instances, various aspects of the invention may be shown exaggerated or enlarged to facilitate an understanding of the invention. Therefore, the drawings may not be to scale.

FIG. 1 shows an embodiment of an autonomous underwater vehicle used for the system and method.

FIG. 2 shows one embodiment of the tracked path for an autonomous underwater vehicle.

FIG. 3 shows a sidescan mosaic with local magnetic field overlay and local magnetic field along-track signal anomaly.

FIG. 4 shows the magnetometer data from an example autonomous underwater vehicle survey of seafloor power transmission cables.

### BACKGROUND

Attention and resources are being invested in offshore energy. For example, in addition to traditional oil and gas operations, offshore wind companies now bid hundreds of millions of dollars each year for the right to develop turbine fields. As the offshore energy industry continues to grow, it will drive an increase in installation of offshore turbines and associated infrastructure. This will bring both new opportunities and challenges.

Offshore infrastructure monitoring is an important component of offshore energy, including the transition to renewable wind energy offshore. Underwater power transmission cables are and will for the foreseeable future remain a vital part of any offshore energy generation, including wind farms. These cables are used to transfer power between turbine arrays and ultimately to shore for distribution through land-based power transmission infrastructure. Although vital to the offshore power generation system, these cables are vulnerable to failures. These vulnerabilities are further complicated because the electrical cables reside subsea, making it difficult for an operator to monitor their location and movement, particularly as subsea cables are known to move over time in currents and tides.

It is important to create and maintain reliable mapping of these underwater cables for future development and in case of maintenance or repair. As offshore energy generation expands, it will be critical that the complex networks of inter-turbine cables and power export cables are monitored to ensure reliability and the cost-effective operation of the generating facilities. Similarly, any areas where power is transmitted by seafloor cable can benefit from reliable, cost effective monitoring. Accordingly, there is a present need for a rapid means of cable survey to detect issues that can disrupt power delivery.

Surveying also has an important role in the ecological, conservation and academic arenas. For example, surveying assists in understanding impact and demonstrating mitigation to Special, Sensitive, or Unique (“SSU”) resources such as intertidal flats, eelgrass, hard and Complex Bottom, N. Atlantic Right Whale, Fin Whale and Humpback Whale core habitat. SSU resources often require efforts such as horizontal drilling and cable burial to minimize the impact to the marine environment.

Cable surveys are often conducted from manned surface vessels using towed systems, Remotely Operated Vehicles (“ROVs”) and divers. Sidescan sonar equipment, cameras, and magnetometers can all be deployed as towed systems. For instance, bathymetry, sidescan sonar, sub-bottom profiling and video imagery can be collected to document the cable route. The current system has several drawbacks and limitations. For instance, these systems cannot always be deployed at the same time in these configurations, necessitating multiple passes over the same area to collect a full data set. Additionally, the navigation and positional accuracy of towed systems can be compromised as current, boat speed, and boat motion all contribute to the location uncertainty of a towed system. These surveys are also often costly, requiring numerous crew and equipment.

The instant method and system of local magnetic field detection present an advantage over sidescan and camera imaging alone. When a cable is trenched into the sea floor or buried by sediment, co-registered data including magnetic field measurements can better inform localization than sea-floor imagery alone. This method uses the magnetic signals that are generated by Alternating Current (“AC”) or Direct Current (“DC”) power transmission in buried and exposed seafloor cables. The current passing through the cables generates a magnetic field, which creates a magnetic flux density dependent on current load.

The measured magnetic field of such a cable is proportional to distance from the sensor to the source and thus strongest when the distance between the source and sensor reaches a minimum. By evaluating the strength of the magnetic field, the cable proximity can be estimated, but variations in field strength due to burial depth or other conditions can present challenges to along-track localization. Therefore, the inventive method uses transecting runs across the cable path so that the maximum values of the induced magnetic field correspond to the intersection of the vehicle path with the cable.

It is also preferable to use autonomous underwater vehicles (“AUVs”) to survey subsea cables. In the prior art, AUVs have been used to inspect seafloor cable routes before installation using sidescan sonars. In some cases, AUVs have even been employed to lay cable themselves. Cable following behaviors have been demonstrated on AUVs using optical feedback over limited ranges, but these systems are not effective if infrastructure is covered by sediment such is often the case with underwater cables. The inventive method addresses these issues by detecting the cable's magnetic field. Thus, it provides a more accurate cable detection and development of adaptive behaviors based on cable location.

As an additional benefit of the current invention, ecological impacts of offshore infrastructure can be identified using the inventive method and system. The ecological impacts from electromagnetic fields on marine life are still poorly understood but are of concern to coastal managers and stakeholders necessitating data collection and evaluation impacts. Magnetometers can be used to detect induced magnetic fields that are emitted into the marine environment by power transmission cables and these data can be compared to ecosystem and benthic biology health as related to proximity to cable routes

The invention provides a low-cost method that can be used by industry to monitor sea floor cable infrastructure and relevant environmental conditions of the surrounding benthic environment. Improved monitoring can increase awareness of the condition of sub-sea infrastructure and ultimately reduce costs for industry.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies.

This method of survey can be used to monitor submarine export cable routes, inter-array cables, hybrid telecommunication cables and the condition of subsea infrastructure as well as the environmental impact of cable installations.

The method comprises using an AUV to cover a series of transects across a known cable corridor. The method provides valuable data about the cable and the surrounding benthic environment while also generating a series of waypoints for cable localization based on the signal maximum detected by a magnetometer.

Underwater power transmission cables produce a strong electromagnetic signature that can be used to localize the cable position even when buried or trenched into the seafloor. By surveying a known cable corridor with a series of perpendicular transects, the local maximum values of the magnetic signature of the cable can be used as a proxy to identify theses cable locations. The maximum values of the induced magnetic field correspond to the intersection of the vehicle path with the cable.

Based on these local maximums, a series of waypoints are generated to create a map of the cable routes. This information can inform managers of cable migration while also providing a basis for follow-up missions to map the full cable in a continuous route running parallel to the cable path and inform AUV navigation once cable routes have been localized

AUVs can offer precise navigation and control making them well suited for accurately localizing targets on the seafloor. One suitable AUV for the method is a commercially available REMUS 600 AUV.

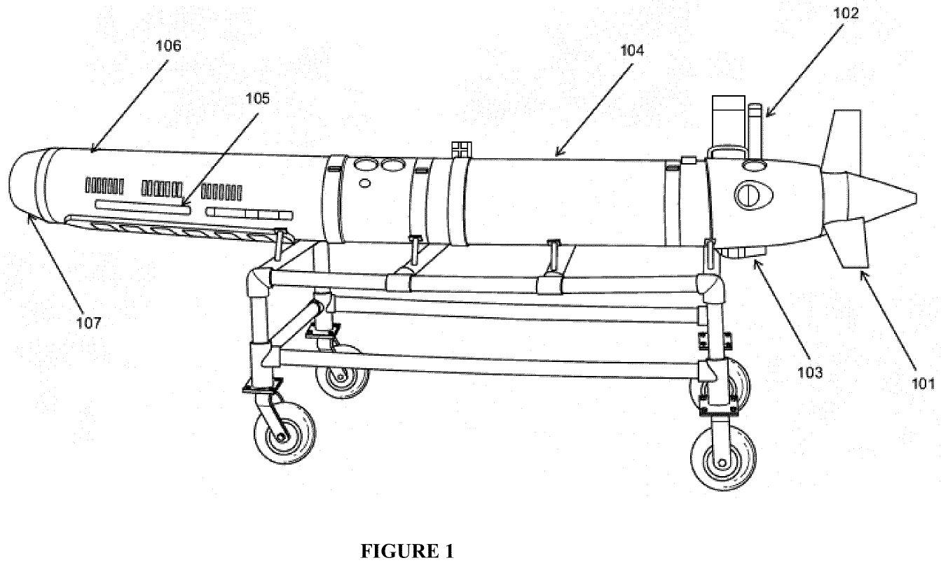

An embodiment of an AUV suitable for this method and system is shown in FIG. 1a and FIG. 1b. As depicted the AUV 100 is equipped with a propulsion means 101, in this case, a propeller and motor. The AUV 100 may also comprise a GPS and/or wi-fi enabled antenna 102, navigation transducers 103, and side scan sonar 105. In a preferred embodiment, the AUV 100 is modular, with for example, a forward module 106 and an aft module 104, so that it may be equipped with user preference sensors, including one or more magnetometers located in the forward payload compartment at 107.

Preferably, the AUV 100 used is adaptable to operate with many different sensors, imaging, and tracking devices. In one or more embodiments, the AUV 100 can also be equipped with a suite of sensors to detect and image seafloor cables. For instance, a suitable suit of sensors may comprise such commercially available sensors as: an Edgetech 2205 dual frequency sidescan sonar operating at 230 kHz and 900 kHz, an integrated Edgetech Sub Bottom profiler 424 was used to image below the sea floor, video or still camera imagery of the seafloor, and multi-element gradiometers to collect additional high-resolution magnetics data.

In one or more embodiments, multiple magnetometers are fitted to a single AUV. In other embodiments, a single magnetometer is used and fitted to a relatively small AUV to save cost and/or storage space.

In one or more embodiments, a self-compensating magnetometer (“SCM”) is used. The SCM internally compensates for the attitude of the AUV within the earth's field as well as the effects related to the strength of the electric currents associated with the vehicle propulsion and other vehicle electronics. One such suitable commercially available SCM is An Ocean Floor Geophysics (“OFG”) Self-Compensating Magnetometer (“SCM”).

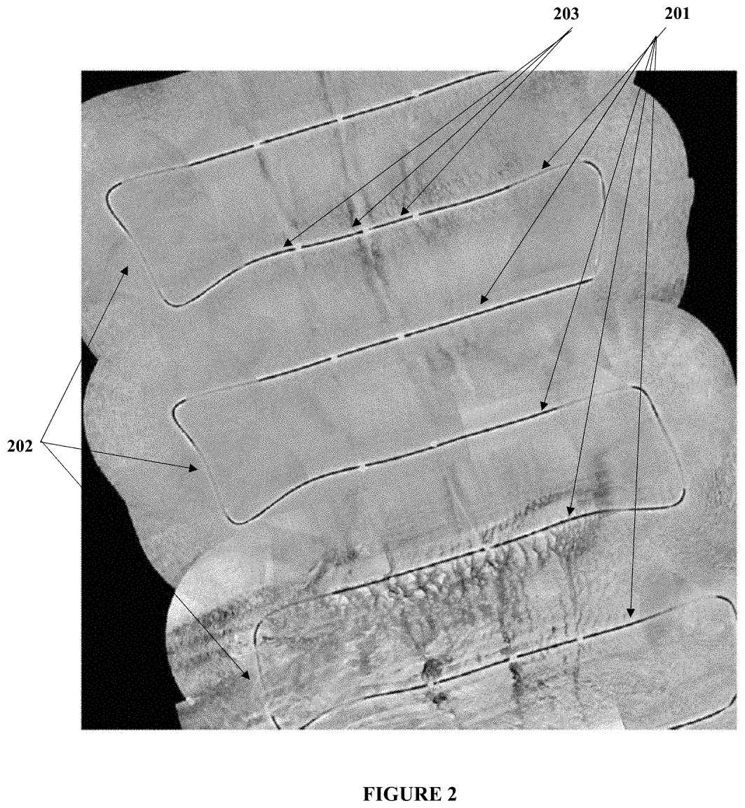

In one or more embodiments, the method is performed by actuating the AUV 100 with onboard magnetometer over the designated survey area. The AUV 100 navigates a series of perpendicular transects. One embodiment of such a route is shown at FIG. 2. The transects 201 are shown as dark lines on the subsurface imagery. In one embodiment, the transects are approximately 500 m in length. However, the length may vary based on the survey size. For example, the transects 201 may be approximately 10 to 100 meters for a smaller survey field and 1,600 meters for an expansive survey field. In one or more embodiments, the between tracks 202 may be approximately 100 meters in length. In other embodiments, the between tracks 202 vary in size based on the size of the survey field and transects 201. As depicted in FIG. 2, the small, lightly shaded dots, for example 203, represent intersections of cable routes and AUV path of travel.

In one or more embodiments, the waypoints identified are used to plan subsequent missions that will follow the cable route based on the point-to-point locations identified from magnetometer data acquired from the preceding transects. In this manner a cable route could be surveyed with full coverage using additional sensors such as sidescan and cameras.

Improved filtering of SCM data will yield higher signal to noise ratios and further increase the reliability of cable detection.

### EXAMPLE 1

In order to demonstrate the effectiveness of the inventive method, an experiment was run between Martha's Vineyard and Falmouth Massachusetts. The power transmission cables between Martha's Vineyard and Falmouth, Massachusetts were selected as a test site due to the accessibility by boat and because the cables provide power and communication to the island but are vulnerable to failure.

In recent surveys conducted, the most recently installed hybrid power transmission cable to Martha's Vineyard was evaluated with towed systems and an ROV to image the proposed cable route and post-installation of the cable.

The AUV was programmed to followed 500 m long track lines perpendicular to the cable corridor, with a between track distance of 100 m. Transects of the known cable corridor were used to map two parallel offshore power cables. Cables 91 and 97 both lay in the cable corridor as well as portions of the now abandoned 100 cable. Cable 91 was installed in 1986. It has failed 6 times, but repairs have kept it operational. Cable 97 was installed in 1990 and remains operational. Both cables have a 13 MVA capacity rated at 25 kV and continue to provide power to the Vineyard. Cable 100 has been abandoned and no longer provides power to the vineyard but remains on the sea floor.

An Ocean Floor Geophysics (“OFG”) Self-Compensating Magnetometer (“SCM”) was installed on a REMUS 600 AUV for this example.

The SCM is a commercially available system that internally compensates for the attitude of the AUV within the earth's field as well as the effects related to the strength of the electric currents associated with the vehicle propulsion and other vehicle electronics.

The use of a REMUS 600 allowed for additional sensors to validate the measurements of the smaller SCM. An Edgetech 2205 dual frequency sidescan sonar operating at 230 kHz and 900 kHz and an integrated Edgetech Sub Bottom profiler 424 were used to image below the sea floor. A multi-element gradiometer was used to collect additional high-resolution magnetics data. This data was compared to that of the SCM to further validate the commercially available single-element sensor and characterize the magnetic signature of the power transmission cables.

The data sets generated by this example survey work was analyzed and imported in ArcGIS to generate a geospatial representation of the information that was collected. This allowed for data comparison in the form of overlays and allowed the research team to identify and compare cable route detection between sensors. Multiple data types were obtained including sidescan sonar imagery, bathymetric data, sub-bottom imagery and magnetic intensity data. ArcGIS Pro 2.4.1 and spatial analyst extension (“ESRI”) software was used to create information overlays and facilitate the rasterization of point data.

Along track bathymetric depth was obtained using the vehicle depth and altitude of the vehicle above the seafloor. Subsequently, a natural neighbor interpolation produced an approximate, continuous bathymetric map.

Sidescan sonar imagery was processed and mosaiced using SonarWiz 6 (Chesapeake Technology) and used as a base map in the ArcGIS software where it served to ground-truth and provide a visual representation of the true location of the cable features.

The features cannot be continuously detected in these images as the cables are buried beneath sediment in some locations, but even where the cable itself is not visible, the disruption of sediment associated with the cable routes reveal the approximate cable location.

The total magnetic intensity acquired by the SCM is automatically corrected by reducing vehicle noise and accounting for the earth's magnetic field. These data points collected by the SCM where turned into a 5 m grid by averaging out the points at that location. Each of these data sets were compared in geo-referenced space to provide a visual representation of cable route and surrounding area. To further improve signal detection, The SCM data was clipped to eliminate vehicle turns and processed to evaluate each track-line independently.

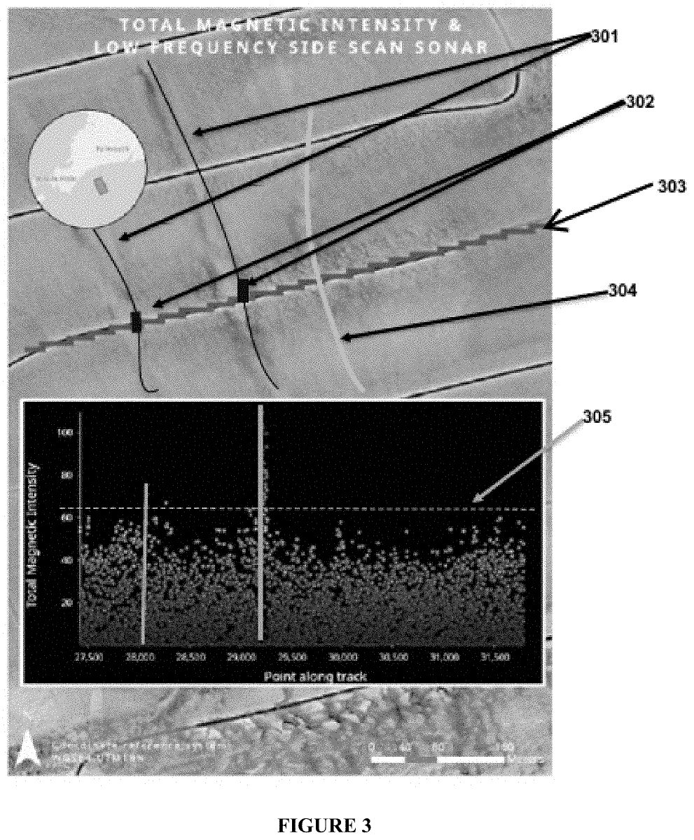

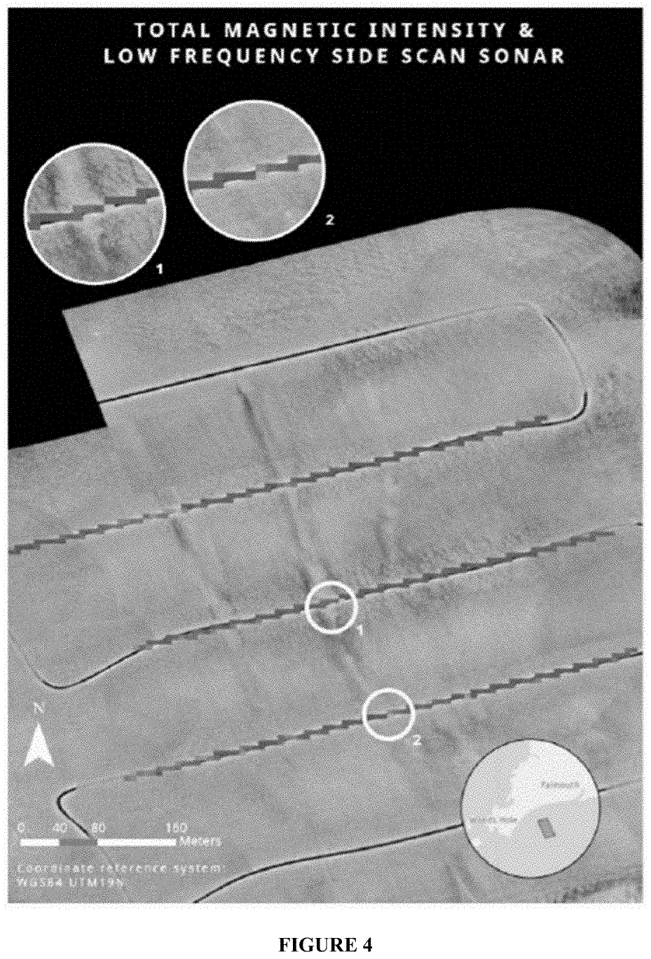

Visual correlations of the cable location were drawn between sidescan (see FIG. 3 and FIG. 4), sub-bottom, gradiometer and SCM data. Each high-power sensor was able to collect data that indicate the cable location. This information was then used to validate the detections seen in the SCM data.

While the SCM data exhibited noise occurring in the transitions from one transect to the next, the data was clipped to see the cable signature within the individual transects, shown in FIG. 3.

Turning to FIG. 3, the power transmission cables 301 are shown as dark lines in the image. Detection events 302 are depicted as small, shaded rectangles on the AUV path transecting the cable route 303. The lighter shaded line depicts a non-energized power transmission cable 304 which has no major magnetic anomalies detected by the system. The graphing overlay shows the detection threshold 305.

This method provided a reference for cable location within 5 meters of the cable as imaged by the side sonar. Deviations from the mean along-track field value were used to detect the presence of an anomaly for each track line. The experimental data shows correlation of multiple detections in the SCM data with cable locations seen in the mosaiced sidescan data. FIG. 4 shows SCM data overlaid onto a low frequency sidescan sonar mosaic of the survey area.

For the purpose of understanding the Method and System for Subsea Cable Localization, references are made in the text to exemplary embodiments of a Method and System for Subsea Cable Localization, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Although the invention has been described with reference to the above example, it will be understood that modifications and variations are encompassed within the spirit and scope of the invention. Accordingly, the invention is limited only by the following claims. CLAIMS

1. A method for seafloor survey comprising:
a) fixing at least one magnetometer to an autonomous underwater vehicle, wherein said magnetometer reads magnetic field values;
b) actuating said autonomous underwater vehicle so that it tracks along a series of perpendicular transects within a designated subsea survey field;
c) mapping the maximum values of induced magnetic field read by said magnetometer; and
d) generating a series of waypoints based on said maximum values through geospatial representation.

2. The method of claim 1 wherein said subsea survey field comprises one or more underwater cables and wherein said maximum values of induced magnetic field correspond to the location of said one or more underwater cables, said one or more underwater cables having a length.

3. The method of claim 1 wherein each of said perpendicular transects is between 100 and 1600 meters long.

4. The method of claim 2 wherein said series of waypoints is used to direct a survey by said autonomous underwater vehicle or a second autonomous underwater vehicle of the entire length of said one or more underwater cables.

5. The method of claim 1 wherein said magnetometer is self-compensating.

6. The method of claim 1 wherein a means to image the seafloor is fixed to said autonomous underwater vehicle to image below said seafloor.

7. A method for subsea cable surveying comprising:
a) fixing at least one magnetometer, and at least one seafloor imaging sensor to an autonomous underwater vehicle, wherein said magnetometer reads magnetic field values that can be co-registered with said at least one seafloor imaging sensor;
b) actuating said autonomous underwater vehicle so that it tracks along a series of perpendicular transects within a designated survey field;
c) mapping the maximum values of induced magnetic field read by said magnetometer;
d) generating a series of waypoints based on said maximum values; and
e) overlaying imagery obtained from said sidescan sonar imager and said sub bottom profiler on said series of waypoints.

8. The method of claim 7 wherein each of said perpendicular transects is 100 meters long.

9. The method of claim 7 wherein said series of waypoints is used to direct a survey by said autonomous underwater vehicle or a second autonomous underwater vehicle of the entire length of said one or more underwater cables.

10. The method of claim 7 wherein said magnetometer is self-compensating.

11. The method of claim 7 wherein said at least one seafloor imaging sensor comprises sidescan sonar.

12. The method of claim 7 wherein said at least one seafloor imaging sensor comprises least one sub bottom profiler to an autonomous underwater vehicle.
